(19) United States
(12) Patent Application Publication
(10) Pub. No.: US 2007/0287470 A1
(43) Pub. Date: Dec. 13, 2007

(54) METHOD AND SYSTEM FOR ENABLING ACCESS TO EMERGENCY SERVICES VIA A HANDHELD COMMUNICATION DEVICE

(76) Inventor: Tony Kirke, San Francisco, CA (US)

Correspondence Address: MCANDREWS HELD & MALLOY, LTD, 500 WEST MADISON STREET, SUITE 3400, CHICAGO, IL, 60661, US

(21) Appl. No.: 11/422,664

(22) Filed: Jun. 7, 2006

(51) Int. Cl. H04Q 7/20

(52) U.S. Cl. 455/456.1; 455/411

(57) ABSTRACT

A first handheld communication device may generate a wireless emergency signal and communicate it to a second handheld communication device. The wireless emergency signal may consist of location and identification information of the first handheld communication device. The wireless emergency signal may be generated as a result of a user input. In response to receiving the wireless signal, the second handheld communication device may route the emergency signal to a remote device, which may terminate and process emergency signals. The emergency signal may be routed to the remote device via a router. Upon routing of the emergency signal, the second handheld communication device or router may send a signal indicating the routing to the first handheld communication device. Additionally, upon reception of the emergency signal at the remote device, an acknowledgement signal may be communicated to the first handheld communication device via the second handheld communication device and/or router.

### CROSS-REFERENCE TO RELATED APPLICATIONS/INCORPORATION BY REFERENCE

This application makes reference to:

U.S. patent application Ser. No. ______ (Attorney Docket No. 17149US01) filed on even date herewith;

U.S. patent application Ser. No. ______ (Attorney Docket No. 17150US01) filed on even date herewith;

U.S. patent application Ser. No. ______ (Attorney Docket No. 17151US01) filed on even date herewith;

U.S. patent application Ser. No. ______ (Attorney Docket No. 17152US01) filed on even date herewith;

U.S. patent application Ser. No. ______ (Attorney Docket No. 17153US01) filed on even date herewith; and

U.S. patent application Ser. No. ______ (Attorney Docket No. 17154US01) filed on even date herewith.

Each of the above stated applications is hereby incorporated herein by reference in its entirety.

### FIELD OF THE INVENTION

Certain embodiments of the invention relate to communication of information within a network. More specifically, certain embodiments of the invention relate to a method and system for enabling access to emergency services via a handheld communication device.

### BACKGROUND OF THE INVENTION

Wireless technology is revolutionizing personal connectivity by providing freedom from wired connections. Conventional wireless connectivity protocols for handheld communication devices, such as Bluetooth®, may provide a small form-factor, low-cost radio solution which may support links between computers, mobile phones and/or other portable and handheld communication devices. Bluetooth® wireless technology is an international, open standard for allowing intelligent devices to communicate with each other through wireless, short-range communications. The Bluetooth® technology allows a Bluetooth® compliant device, such as a Bluetooth®-enabled computer, computer mouse, computer keyboard, speakers, or a handheld communication device, for example, to support its own connections, without wires, cables or any direct action from a user. Bluetooth® is currently incorporated into numerous commercial products including laptops, PDAs, cell phones, keyboards, and printers, for example.

Bluetooth® handheld communication devices, such as mobile telephones and PDAs, are evolving to become more complex as such devices may be adapted to transmit and receive audio and/or video information. However, communicating data, such as audio and video data between Bluetooth®-enabled devices via a Bluetooth® connection requires increased power consumption and may be achieved at data rates that are slower than data rates offered by high-speed connections. Furthermore, conventional wireless connectivity standards for handheld communication devices, such as the Bluetooth® standard, are effective within a limited distance range.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for enabling access to emergency services via a handheld communication device, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating communication between a plurality of handheld communication devices in an ad-hoc network, in accordance with an embodiment of the invention.

FIG. 2 is a diagram illustrating a plurality of ad-hoc networks comprising handheld communication devices, in accordance with an embodiment of the invention.

FIG. 3 is a diagram illustrating communication of information between handheld communication devices, in accordance with an embodiment of the invention.

FIG. 4 is a diagram illustrating communication of information between handheld communication devices, in accordance with an embodiment of the invention.

FIG. 5 is a diagram illustrating wireless communication of information by a handheld communication device, in accordance with an embodiment of the invention.

FIG. 6 is a flowchart illustrating exemplary steps for communicating information within a network, in accordance with an embodiment of the invention.

### DETAILED DESCRIPTION OF THE INVENTION

Certain embodiments of the invention may be found in a method and system for enabling access to emergency services via a handheld communication device. In one embodiment of the invention, a first handheld communication device may generate a wireless signal and communicate it to a second handheld communication device. The wireless signal may contain location and identification information of the first handheld communication device. The wireless signal may be generated as a result of a user input. In response to receiving the wireless signal, the second handheld communication device may determine whether the received wireless signal is an emergency signal. If the wireless signal is indeed an emergency signal, the second handheld communication device may route the emergency signal to a remote device, which may terminate and process emergency signals.

The wireless signal may be routed, by the second handheld communication device to a remote device, via a routing device or another handheld communication device.

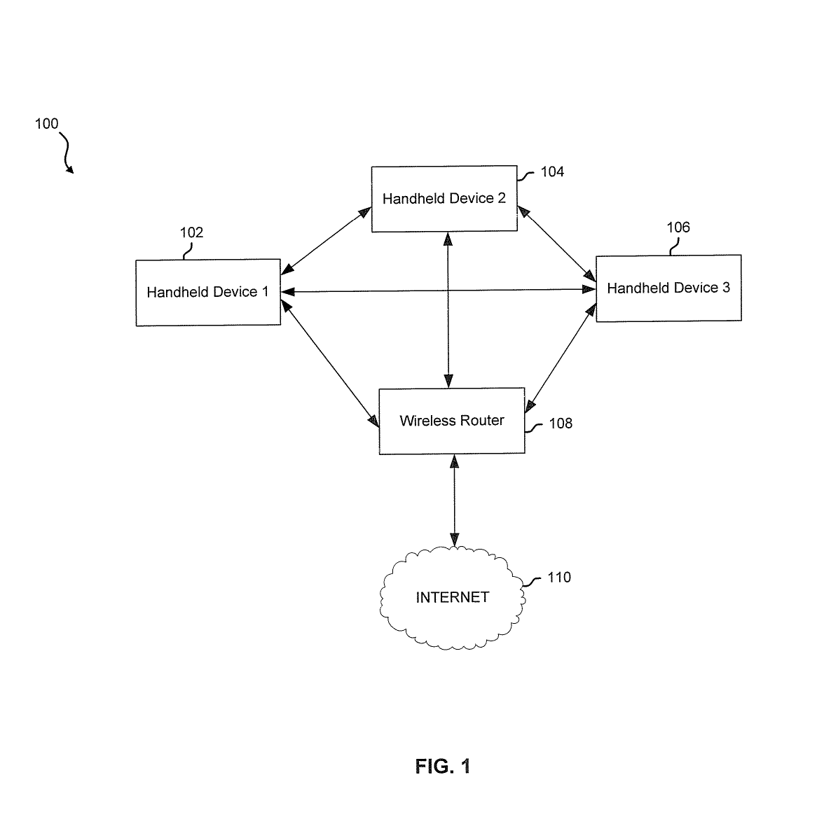

FIG. 1 is a diagram illustrating communication between a plurality of handheld communication devices in an ad-hoc network, in accordance with an embodiment of the invention. Referring to FIG. 1, the ad-hoc network 100 may comprise a plurality of handheld communication devices, such as handheld communication devices 102, 104, and 106. The handheld communication devices 102, 104, and 106 may each comprise suitable circuitry, logic, and/or code and may communicate information wirelessly within the ad-hoc network 100. For example, handheld communication devices 102, 104, and 106 may communicate voice or data between each other over extended ranges, without the use of a network device, such as an access point, a base station, a bridge, a router, and/or a switch, for example, to facilitate such communication. The extended range may be much greater than the range provided by Bluetooth.

In one embodiment of the invention, handheld communication devices 102, 104, and 106 may utilize instant messaging (IM) to communicate data within the ad-hoc network 100. For example, during an initial formation of the ad-hoc network 100, the handheld communication device 102 may detect the presence of the handheld communication device 104. Handheld communication devices 102 and 104 may then exchange identification information related to the devices 102 and 104 and/or to the corresponding users of the devices 102 and 104. For example, handheld communication devices 102 and 104 may exchange user identification information. After handheld communication devices 102 and 104 exchange user identification information and authenticate each other, a connection may be established for a wireless exchange of data between the handheld communication devices 102 and 104. In one embodiment of the invention, the connection may be utilized to filtrate a messaging session such as, for example, an instant messaging session between devices.

After an IM wireless connection is established between handheld communication devices 102 and 104, a third handheld communication device 106, located within operating range of handheld communication devices 102 and 104, may be detected by device 102 and/or device 104. After handheld communication device 106 is detected by handheld communication device 102 and/or handheld communication device 104, identification information may be exchanged between handheld communication device 106 and handheld communication devices 102 and 104. Handheld communication device 106 may then be accepted within the ad-hoc network 100 and IM communication may be established between handheld communication devices 102, 104, and 106.

In another embodiment of the invention, handheld communication devices 102, 104, and 106 may each communicate with the wireless router 108. The wireless router 108 may be communicatively coupled to the Internet 110. In this regard, one or more of the handheld communication devices 102, 104, and 106 may operate both within the ad-hoc network 100 and within an infrastructure network comprising, for example, the router 108 and one or more devices communicatively coupled to the Internet 110.

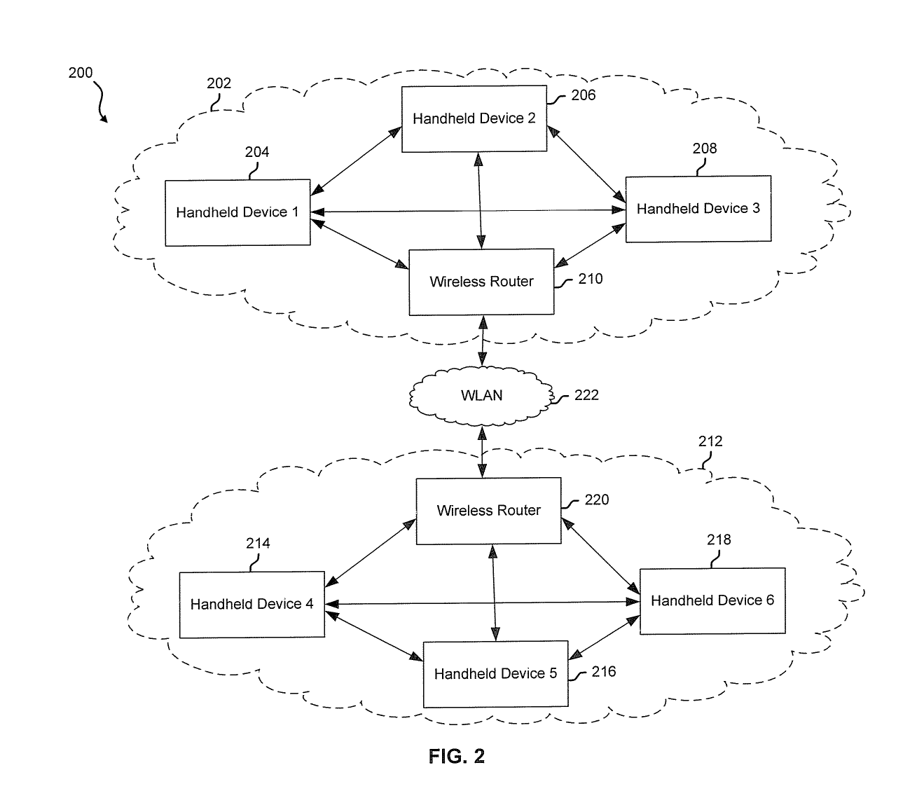

FIG. 2 is a diagram illustrating a plurality of ad-hoc networks comprising handheld communication devices, in accordance with an embodiment of the invention. Referring to FIG. 2, the communication infrastructure 200 may comprise ad-hoc networks 202 and 212. The ad-hoc network 202 may comprise a plurality of handheld communication devices, such as handheld communication devices 204, 206, and 208. The handheld communication devices 204, 206, and 208 may each comprise suitable circuitry, logic, and/or code and may communicate information wirelessly over an extended range within the ad-hoc network 202. For example, handheld communication devices 204, 206, and 208 may communicate voice or data between each other over extended ranges, without the use of a network device, such as an access point, a base station, a bridge, a router, and/or a switch, for example, to facilitate such communication. The extended range may be much greater than the range provided by Bluetooth.

Similarly, the ad-hoc network 212 may comprise a plurality of handheld communication devices, such as handheld communication devices 214, 216, and 218. The handheld communication devices 214, 216, and 218 may each comprise suitable circuitry, logic, and/or code and may communicate information wirelessly within the ad-hoc network 212. For example, handheld communication devices 214, 216, and 218 may communicate voice or data between each other over extended ranges, without the use of a network device, such as an access point, a base station, a bridge, a router, and/or a switch, for example, to facilitate such communication. The extended ranges may be much greater than the range provided by Bluetooth.

In one exemplary embodiment of the invention, handheld communication devices 204, 206, and 208 may utilize instant messaging (IM) to wirelessly communicate data over an extended range within the ad-hoc network 202 when the devices are within operating range of each other. Similarly, handheld communication devices 214, 216, and 218 may utilize, for example, instant messaging (IM) to communicate data within the ad-hoc network 212. One or more of the handheld communication devices 204, 206, and 208, within ad-hoc network 202, and handheld communication devices 214, 216, and 218, within ad-hoc network 212, may communicate with the wireless routers 210 and 220, respectively. The wireless routers 210 and 220 may be communicatively coupled to a wireless local area network (WLAN) 222. In this regard, one or more of the handheld communication devices 204, . . . , 208 may simultaneously communicate information to one or more handheld communication devices within the ad-hoc network 202, and to one or more handheld communication device within the ad-hoc network 212, via the wireless routers 210, 220 and the WLAN 222. Similarly, one or more of the handheld communication devices 214, . . . , 218 may communicate information within the ad-hoc network 212 and with one or more handheld communication device within the ad-hoc network 202, via the wireless routers 210, 220 and the WLAN 222.

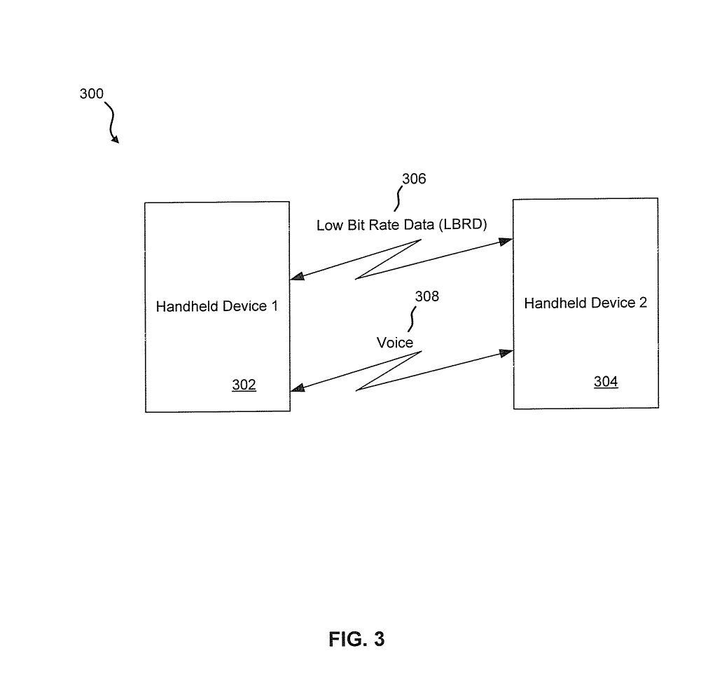

FIG. 3 is a diagram illustrating communication of information between handheld communication devices, in accordance with an embodiment of the invention. Referring to FIG. 3, handheld communication devices 302 and 304 may form an ad-hoc network 300. In this regard, handheld communication devices 302 and 304 may exchange information without using an intermediate communication device, such as an access point, a base station, a bridge, a router, and/or a switch that facilitates communication between the handheld communication devices 302 and 304. The handheld communication devices 302 and 304 may comprise, for example, a cell phone or a personal digital assistant (PDA). Furthermore, the handheld communication devices 302 and 304 may communicate low bit-rate data (LBRD) 306 and/or voice data 308. The LBRD 306 may be exchanged during, for example, an instant messaging (IM) connection established between the handheld communication devices 302 and 304.

In operation, the handheld communication device 302 may detect the presence of the handheld communication device 304 when the latter is within operating range of the former. Handheld communication devices 302 and 304 may then exchange identification information related to the devices 302 and 304 and/or identification information related to the corresponding users of the devices 302 and 304. After handheld communication devices 302 and 304 exchange user identification information and authenticate each other, a connection may be established between handheld communication devices 302 and 304 for a wireless exchange of LBRD 306 and/or exchange of voice information 308.

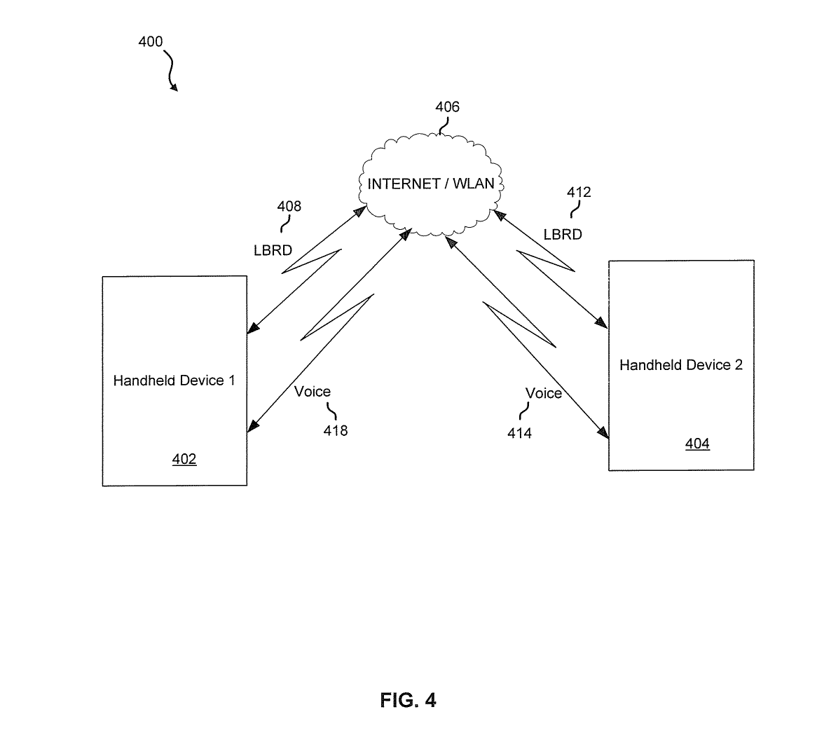

FIG. 4 is a diagram illustrating communication of information between handheld communication devices, in accordance with an embodiment of the invention. Referring to FIG. 4, handheld communication devices 402 and 404 may form a communication infrastructure 400. The communication infrastructure 400 may also comprise the Internet or a WLAN 406. The handheld communication devices 402 and 404 may exchange information via the Internet or WLAN 406. The handheld communication devices 402 and 404 may comprise, for example, a cell phone or a personal digital assistant (PDA). Furthermore, the handheld communication devices 402 and 404 may communicate low bit-rate data (LBRD) 408 and 412 and/or voice data 418 and 414.

For example, LBRD 408 may be communicated between the Internet/WLAN 406 and the handheld communication device 402, and LBRD 412 may be communicated between the Internet/WLAN 406 and the handheld communication device 404. Similarly, voice data 418 may be communicated between the Internet/WLAN 406 and the handheld communication device 402, and voice data 414 may be communicated between the Internet/WLAN 406 and the handheld communication device 404. The LBRD 408 and 412 may be exchanged during, for example, an instant messaging (IM) connection established between the handheld communication devices 402 and 404 via the Internet/WLAN 406.

In operation, the handheld communication device 402 may detect the presence of the handheld communication device 404 via the Internet/WLAN 406. Handheld communication devices 402 and 404 may then exchange identification information related to the devices 402 and 404 and/or identification information related to the corresponding users of the handheld communication devices 402 and 404. After handheld communication devices 402 and 404 exchange user identification information and authenticate each other, a connection may be established between handheld communication devices 406 and 408 via the Internet/WLAN 406 for a wireless exchange of LBRD 408 and 412 and/or exchange of voice information 418 and 414.

In one embodiment of the invention, handheld communication device 402 may store identification information of handheld communication device 404, prior to pairing the devices 402 and 404 or prior to establishing any connection or communication between the devices 402 and 404 when the latter is within operating range of the former. In this regard, handheld communication device 404 may be “pre-authorized” to communicate with handheld communication device 402. In instances when handheld communication device 404 is pre-authorized for communication with handheld communication device 402, an ad-hoc network connection may be established between devices 402 and 404 at the time handheld communication device 402 detects handheld communication device 404.

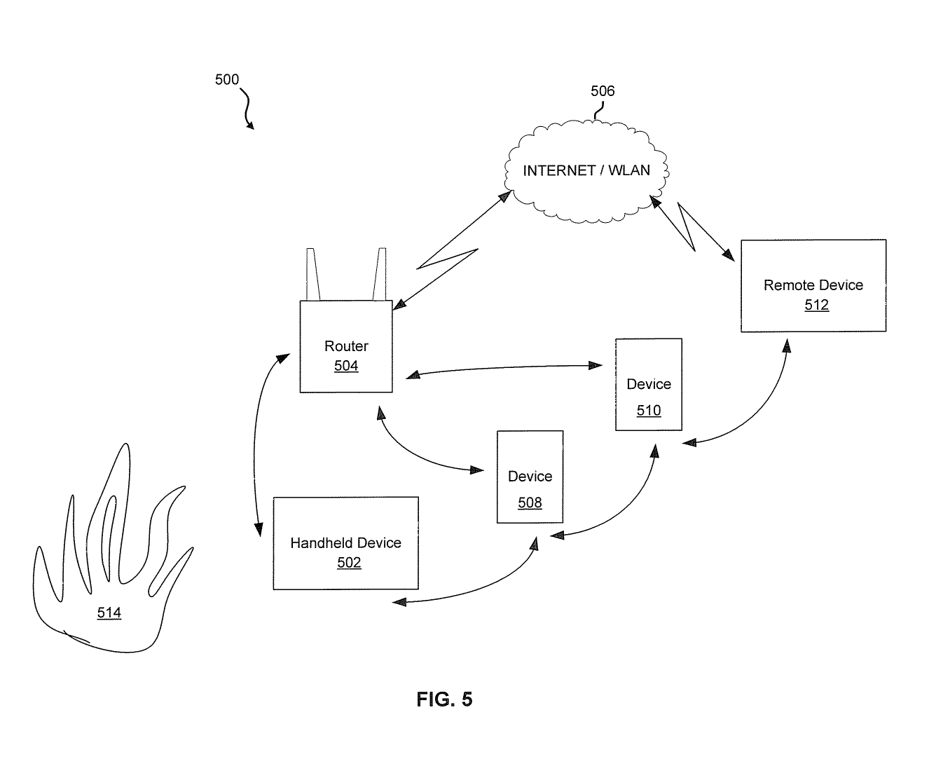

FIG. 5 is a diagram illustrating wireless communication of information by a handheld communication device, in accordance with an embodiment of the invention. Referring to FIG. 5, the communication infrastructure 500 may comprise a handheld communication device 502, a wireless router 504, Internet or WLAN 506, and communication devices 508 and 510, and remote device 512. The communication devices 508 and 510, and remote device 512 may comprise suitable circuitry, logic, and/or code and may enable communication of information wirelessly within the communication infrastructure 500.

For example, information may be communicated among the handheld communication device 502, the wireless router 504, the communication devices 508 and 510, the remote device 512, and the Internet/WLAN 504. In operation, the handheld communication device 502 may be at a location where there is an emergency such as, for example, a fire 514. The handheld communication device 502 may provide support for communication of emergency information and may be in compliance with Enhanced 911 (E911) requirements. Therefore, the handheld communication device 502 may send and receive emergency information.

In an embodiment of the invention, the handheld communication device 502 may comprise integrated GPS functionality, which may provide the location of the distressed user dealing with the emergency, the fire 514, for example.

If, for example, there is a fire 514, a user input may trigger the handheld communication device 502 to transmit an emergency signal. The emergency signal may be communicated wirelessly to other handheld communication devices such as, for example, the devices 508 and 510, or the remote device 512 within the vicinity of the handheld communication device 502. In an embodiment of the invention, the handheld communication device 502 may comprise a panic button, which may be pressed in case of an emergency causing the handheld communication device 502 to transmit an emergency signal.

If the handheld communication device is within operating range of an access point or a wireless router 504, the emergency signal may be routed by the wireless router 504 and communicated to other devices 508 and 510, and remote device 512 via the wireless router 504. In an embodiment of the present invention, the wireless router 504 may relay the signal to other devices via the Internet/WLAN 506, which may send the message to the devices 508 and 510, and remote device 512.

In an embodiment of the invention, the emergency signal generated by the handheld communication device 502 may be routed via the remote device 512 to the appropriate authorities dealing with emergency situations such as, for example, police departments, fire departments, ambulance, and/or other emergency centers. The appropriate authorities may comprise the remote device 512, which may receive the emergency information via the wireless router 504, the Internet/WLAN 506, or another device 508 or 510.

A level or severity of the distress level may be set by the distressed user when sending a distress/emergency signal from the handheld communication device 502, and may be used to determine where and/or with what priority a distress message may be routed. For example, a default device 508 may be identified as the destination for certain types of alerts or distress messages. Accordingly, if the default device 508 is detected, whether in close proximity via direct connection or via a remote connection through Internet/WLAN 506, the alert or distress message may be routed to the default communication device such as, for example, the wireless router 504. In another example, if the device is set up to send a certain distress signal associated with a fire, the destination device may be a device at the nearest fire station.

In an embodiment of the invention, the remote device 512 may be, for example, a computer that routes calls to police stations, fire stations, or ambulances based on, for example, severity of the emergency. The remote device 512 may also be, for example, a computer at a police, fire, or ambulance station that may indicate the presence of an emergency and its location. The remote device 512 may additionally be, for example, a computer at a central monitoring station that monitors emergency signals and dispatches alerts to the appropriate police, fire, or ambulance stations.

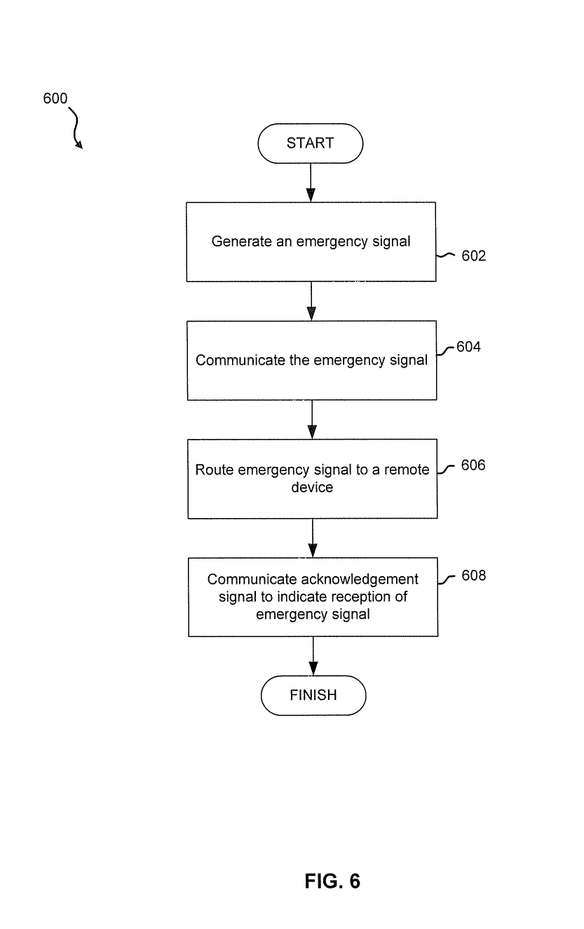

FIG. 6 is a flowchart 600 illustrating exemplary steps for communicating information within a network, in accordance with an embodiment of the invention. Referring to FIGS. 5 and 6, at 602, the handheld communication device 502 may generate a signal, when an event triggers the presence of an emergency, by a user input to the handheld communication device, for example. The handheld communication device 502 may then communicate the generated signal to another device at 604. The other device may be another handheld communication device and/or a routing device. If the other device, upon reception of the signal recognizes that it is an emergency signal, the other device may route the signal to a remote device capable of terminating and processing emergency signals, at 606. A signal acknowledging reception of the emergency signal may then be communicated to the originating handheld communication device at 608.

Other devices may comprise, for example, handheld communication devices or routers in the vicinity of the handheld communication device 502. The router 504 may, for example, route the emergency signal to the remote device 512 directly or via the Internet/WLAN 506 or other routing devices. The remote device 512 may be associated with the appropriate authority to deal with the type of emergency being reported via the emergency signal sent by the handheld communication device 502.

When the signal is routed by another handheld communication device or a router, a response signal may be sent by the other handheld communication device or router to the handheld communication device originally communication the emergency signal. Additionally, when the emergency signal is received at the remote device 512, an acknowledgement signal may be communicated by the remote device 512 to the handheld communication device originally communicating the emergency signal. The acknowledgement signal may indicate reception of the emergency signal at the remote device 512. The acknowledgement signal may be communicated by the remote device 512 via the router 504 and/or other handheld communication devices 508 and 510, which may have contributed to the communication of the emergency signal to the remote device. A signal indicating communication of the acknowledgement signal to the originating handheld communication device may be sent to the remote device by the intermediate communication devices. The originating handheld communication device may comprise, for example, the handheld communication device 502. The intermediate communication devices may comprise, for example, at least one of the handheld communication devices 508 and 510 and the router 504.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for communicating information in a communication system, the method comprising:
receiving at a second wireless handheld communication device (WHCD), a first wireless signal generated by and communicated from a first WHCD, said first wireless signal comprising at least a location and identification of said first WHCD;
in response to receiving said first wireless signal generated by said first WHCD, determining by said second WHCD whether said first wireless signal is a wireless emergency signal; and
if said first wireless signal is a wireless emergency signal, routing said wireless emergency signal by said second WHCD to a remote device, wherein said remote device terminates and processes emergency signals.

2. The method according to claim 1, further comprising routing said wireless emergency signal by said second WHCD to said remote device via at least one routing device communicatively coupling said second WHCD to said remote device.

3. The method according to claim 1, further comprising routing said wireless emergency signal by said second WHCD to said remote device via at least one other WHCD communicatively coupling said second WHCD to said remote device.

4. The method according to claim 3, wherein at least one routing device communicatively couples said at least one other WHCD to said remote device.

5. The method according to claim 1, wherein said first wireless signal is generated in response to receiving at said first WHCD, a user input that triggers said generation and communication of said first wireless signal from said first WHCD.

6. The method according to claim 1, further comprising communicating a first response signal from said second WHCD to said first WHCD when said routing occurs.

7. The method according to claim 1, further comprising receiving at said second WHCD, a response signal from said remote device comprising an acknowledgement that said remote device has received said wireless emergency signal.

8. The method according to claim 7, wherein said response signal comprises an acknowledgement indicating that said remote device has received said wireless emergency signal originating from said first WHCD.

9. The method according to claim 8, further comprising communicating said response signal from said second WHCD to said first WHCD.

10. The method according to claim 9, further comprising notifying said remote device that said response signal was sent to said first WHCD.

11. A system of communicating information by a communication device, the system comprising:
at least one processor within a second wireless handheld communication device (WHCD), that enables reception of a first wireless signal generated by and communicated from a first WHCD, said first wireless signal comprising at least a location and identification of said first WHCD;
said at least one processor within said second WHCD, in response to reception of said first wireless signal generated by said first WHCD, enables determining by said second WHCD whether said first wireless signal is a wireless emergency signal; and
said at least one processor within said second WHCD, if said first wireless signal is a wireless emergency signal, enables routing said wireless emergency signal by said second WHCD to a remote device, wherein said remote device terminates and processes emergency signals.

12. The system according to claim 11, further comprising said at least one processor within said second WHCD enables routing said wireless emergency signal by said second WHCD to said remote device via at least one routing device communicatively coupling said second WHCD to said remote device.

13. The system according to claim 11, further comprising said at least one processor within said second WHCD enables routing said wireless emergency signal by said second WHCD to said remote device via at least one other WHCD communicatively coupling said second WHCD to said remote device.

14. The system according to claim 13, wherein at least one routing device communicatively couples said at least one other WHCD to said remote device.

15. The system according to claim 11, wherein said first wireless signal is generated in response to receiving at said first WHCD, a user input that triggers said generation and communication of said first wireless signal from said first WHCD.

16. The system according to claim 11, further comprising said at least one processor within said second WHCD enables communicating a first response signal from said second WHCD to said first WHCD when said routing occurs.

17. The system according to claim 11, further comprising said at least one processor within said second WHCD enables reception at said second WHCD, of a response signal from said remote device comprising an acknowledgement that said remote device has received said wireless emergency signal.

18. The system according to claim 17, wherein said response signal comprises an acknowledgement indicating that said remote device has received said wireless emergency signal originating from said first WHCD.

19. The system according to claim 18, further comprising said at least one processor within said second WHCD enables communicating said response signal from said second WHCD to said first WHCD.

20. The system according to claim 19, further comprising said at least one processor within said second WHCD enables notifying said remote device that said response signal was sent to said first WHCD.
